(19) United States
(12) Patent Application Publication
(10) Pub. No.: US 2009/0021263 A1
(43) Pub. Date: Jan. 22, 2009

(54) Multi-Ion Potential Sensor and Fabrication thereof

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW); Shien-I Wei, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/778,677

(22) Filed: Jul. 17, 2007

(51) Int. Cl. G01N 27/00; B05D 5/12

(52) U.S. Cl. 324/425; 427/126.5

(57) ABSTRACT

A multi-ion potential sensor is disclosed. The multi-ion potential sensor comprises a substrate, a conductive layer, an isolation layer, a tin oxide (SnO₂) layer and a selective layer. The conductive layer comprises a plurality of independent conductive areas, wherein every conductive area comprises a readout area, a transmissive area and a sensing area, and the transmissive area of every conductive area is packaged by the isolation layer. The tin oxide layer comprises a plurality of independent tin oxide areas, wherein every tin oxide area is deposited on the sensing area, and the selective layer comprises a plurality of independent selective areas, wherein every selective area is set on the tin oxide area. The multi-ion potential sensor has various advantages, such as good sensitivity, low cost, simplicity, disposable, portable and data acquisition by a computer for different applications.

### BACKGROUND OF THE INVENTION

1. Field of the Invention

The present invention generally relates to multi-ion sensor and fabrication, and more particularly to multi-ion potential sensor and fabrication.

2. Description of the Prior Art

At the present day, it is more and more important that the electrochemistry sensor is applied to medical science and environment, such as examining and analyzing human parameters, and environment measurement. Chemical energy could be transformed to electric energy by the electrochemistry sensor, wherein three operation modes of the electrochemistry sensor comprise electric current mode, potential mode and impedance mode.

A multi-ion sensor integrated by combining many kinds of ion sensors is always applied in academic researches and commercial pursuits due to requirements about fabrication, environment, biology and medical science. Traditional multi-ion detect systems applied in laboratories are always large, broken easily and expensive.

In addition, the greater part materials could be printed by screen-printed method, for example plastics, textile fabrics, metals, glasses and ceramics could be printed by screen-printed method. Recently, many people research how to apply screen-printed method to biology and medical science, or electrochemistry sensing technology, such as [R. Koncki and M. Mascini, Screen-printed ruthenium dioxide electrodes for pH measurements, Analytica Chimica Acta 351(1997)143-149]

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

A multi-ion potential sensor fabrication method is disclosed. The method comprises the steps of: providing a substrate; forming a conductive layer on the substrate by using screen-printed method, wherein the conductive layer comprises a plurality of independent conductive areas, and each of the conductive areas comprises a readout area, a transmissive area and a sensing area, wherein the readout area is connected with one side of the transmissive area, and the sensing area is connected with the other side of the transmissive area; deposting a tin oxide layer on the conductive layer by vapor deposition method, wherein the tin oxide layer comprises a plurality of independent tin oxide areas, and each of the tin oxide areas is respectively deposited on each of the sensing areas; forming an isolation layer over each of the transmissive areas; forming a selective layer on the tin oxide layer, wherein the selective layer comprises a plurality of independent selective areas, and each of the selective areas is set on each of the tin oxide areas.

As well, a multi-ion potential sensor is disclosed. The multi-ion potential sensor comprises a substrate, a conductive layer, an isolation layer, a tin oxide (SnO₂) layer and a selective layer. The conductive layer comprises a plurality of independent conductive areas on the substrate, wherein each of the conductive areas comprises a readout area, a transmissive area and a sensing area, and the transmissive area of each of the conductive areas is packaged by the isolation layer. The tin oxide layer comprises a plurality of independent tin oxide areas, wherein each of the tin oxide areas respectively is deposited on each of the sensing areas, and the selective layer comprises a plurality of independent selective areas, wherein each of the selective areas is set on each of the tin oxide areas.

A multi-ion potential system is also disclosed, wherein the multi-ion potential system comprises a plurality of amplifiers, a digital multi-meter, a computer, a reference electrode and the multi-ion potential sensor. The computer and the digital multi-meter compute and analyze signals amplified by the amplifiers, wherein the signals are outputted from the multi-ion potential sensor after the reference electrode and the multi-ion potential sensor are immersed in a solution.

The multi-ion potential sensor has various advantages, such as good sensitivity, low cost, simplicity, disposable, portable and data acquisition by a computer for different applications.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A, FIG. 1B and FIG. 1C are diagrams illustrate the fabrication and structure of a multi-ion potential sensor;

FIG. 2 is a diagram depicts a multi-ion potential system;

FIG. 3 and FIG. 4 are diagrams show curves of experimental data of a multi-ion potential system;

FIG. 5 and FIG. 6 are diagrams describe a solid-state reference electrode;

FIG. 7 and FIG. 8 are diagrams illustrate curves of experimental data of a multi-ion potential system;

FIG. 9 is a diagram depicts a multi-ion potential sensor with a urea enzyme film; and

FIG. 10 is a diagram shows a curve of experimental data of a multi-ion potential sensor with a urea enzyme film.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

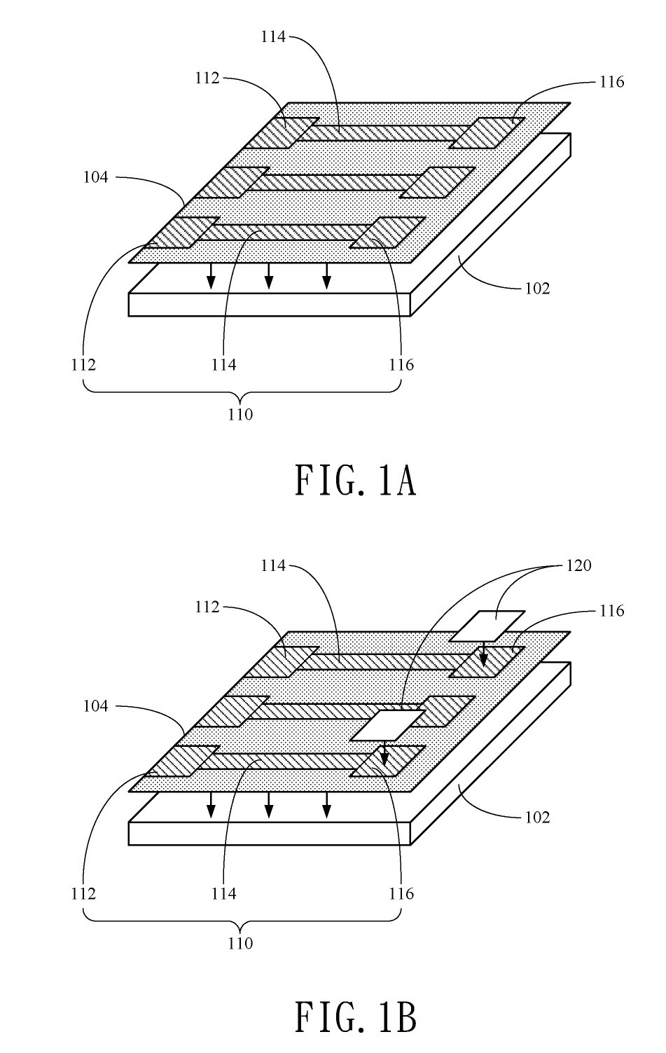

Please refer to FIG. 1A, FIG. 1B and FIG. 1C, which are fabrication and structural diagrams of a multi-ion potential sensor 100. At first, a conductive layer is formed on a substrate 102 by using screen-printed method, as shown in FIG. 1A. The conductive layer comprises a plurality of independent conductive areas 110, and each of the conductive areas 110 comprises a readout area 112, a transmissive area 114 and a sensing area 116, wherein the readout area 112 is connected with one side of the transmissive area 114, and the sensing area 116 is connected with the other side of the transmissive area 114. The conductive layer could comprise carbon to conduct electricity, and the substrate could comprise at least one or any combination of the following: PP (Polypropylene), PC (Polycarbonate), Fluoroethylene Resin, Phenol Resin, UPE (Unsaturated Polyester Resin), Epoxy Resin, Silicone Resins, PU (Polyurethane), PET (Polyrthylene Terephthalate) and PVC (Polyvinyl chloride polymer). The substrate 102 and the conductive layer could be bound by a first conductive paste 104, wherein the first conductive paste 104 could comprise carbon paste and silver paste for conducting electricity.

Please refer to FIG. 1B, a tin oxide (SnO₂) layer is deposited on the conductive layer by vapor deposition method, wherein the tin oxide layer comprises a plurality of independent tin oxide areas 120, and each of the tin oxide areas 120 is respectively deposited on each of the sensing areas 116, wherein the thickness of the tin oxide layer could be 200 nm. Moreover, the vapor deposition method comprises PVD (Physical Vapor Deposition) and CVD (Chemical Vapor Deposition). The physical vapor deposition comprises at least one or any combination of the following: evaporation deposition, ion plating and sputtering deposition, wherein the sputtering deposition comprises RF Sputter. The chemical vapor deposition comprises at least one or any combination of the following: LPCVD (Low Pressure Chemical Vapor Deposition), MPCVD (Metal-organic Chemical Vapor Deposition), PECVD (Plasma-Enhanced Chemical Vapor Deposition) and Photo CVD.

Please refer to FIG. 1C, an isolation layer 130 is formed over each of the transmissive areas 114, wherein the isolation layer 130 and the transmissive area 114 is bound by a second conductive paste 106, which could comprise carbon paste and silver paste for conducting electricity. The isolation layer 130 could comprise at least one or any combination of the following: Epoxy, Silicone, Silica and Silicon Nitride.

Then, a selective layer is formed on the tin oxide layer, wherein the selective layer comprises a plurality of independent selective areas 122, and each of the selective areas 122 is set on each of the tin oxide areas 120. Furthermore, the material of one of the selective areas 122 is different from another for filtering and detecting ions. For example, the material of one of the selective areas 122 could be sodium ion-selective membrane, and the material of another one of the selective areas 122 could be potassium ion-selective membrane, wherein the sodium ion-selective membrane could filter the sodium ions, and the potassium ion-selective membrane could filter the potassium ions.

Please refer to FIG. 1A, FIG. 1B and FIG. 1C, the multi-ion potential sensor 100 is also disclosed, wherein the multi-ion potential sensor 100 comprises the substrate 102, the conductive layer, the isolation layer 130, the tin oxide layer and the selective layer. The conductive layer comprises a plurality of independent conductive areas 110 on the substrate 102, and each of the conductive areas 110 comprises the readout area 112, the transmissive area 114 and the sensing area 116, wherein the isolation layer 130 is formed over each of the transmissive areas 114. The tin oxide layer comprises a plurality of independent tin oxide areas 120, wherein each of the tin oxide areas 120 is respectively deposited on the sensing area 116. The selective layer comprises a plurality of independent selective areas 122, wherein each of the selective areas 122 is respectively set on each of the tin oxide areas 120.

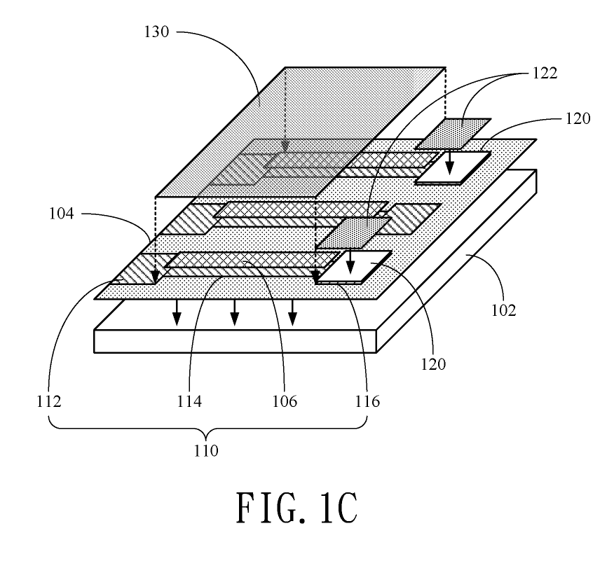

Please refer to FIG. 2, a multi-ion potential system is disclosed. The multi-ion potential system comprises the multi-ion potential sensor 100 and a reference electrode 150 with a reference potential, and the multi-ion potential sensor 100 and the reference electrode 150 are immersed into a solution 160. The reference electrode 150 could comprise Ag and AgCl.

Because selective areas 122 could comprise at least one or any combination of the following: sodium ion-selective membrane and potassium ion-selective membrane according to above-mentioned, ions in the solution 160 could be filtered and detected when the multi-ion potential sensor 100 and the reference electrode 150 are immersed in the solution 160. In another word, sodium ions could be filtered by the sodium ion-selective membrane to be reacted with the tin oxide area 120, and potassium ions could be filtered by the potassium ion-selective membrane to be reacted with the tin oxide area 120. When oxidation-reduction reaction between the multi-ion potential sensor 100 and the solution 160 is resulted, potential signals would be resulted according to the potential difference between the multi-ion potential sensor 100 and the reference electrode 150, and the potential signals could be outputted by the readout areas 112.

The oxidation-reduction reaction between sensing areas 116 of the multi-ion potential sensor 100 and the solution 160 is shown as following:

MₓO_{y}+2yH⁺+2ye⁻←→xM+yH₂O

where M means a metal element; H⁺ means a hydrogen ion; O means an oxygen atom; e⁻ means an electron; and x and y are constant, wherein MₓO_{y} could be SnO₂ in the foregoing.

In addition, the potential of the sensing area 116 is changed linearly with pH as follows:

E=E°−RT ln 10/F pH−RT/F ln a_{H}_{₂}_{O}

Where E° is the reference potential, and a_{H}_{₂}_{O} denotes the activity of water in the solution 160. The last term can be ignored as follows:

E=E°−RT ln 10/F pH

where RT ln 10/F is 0.059 Volt at 25° C.

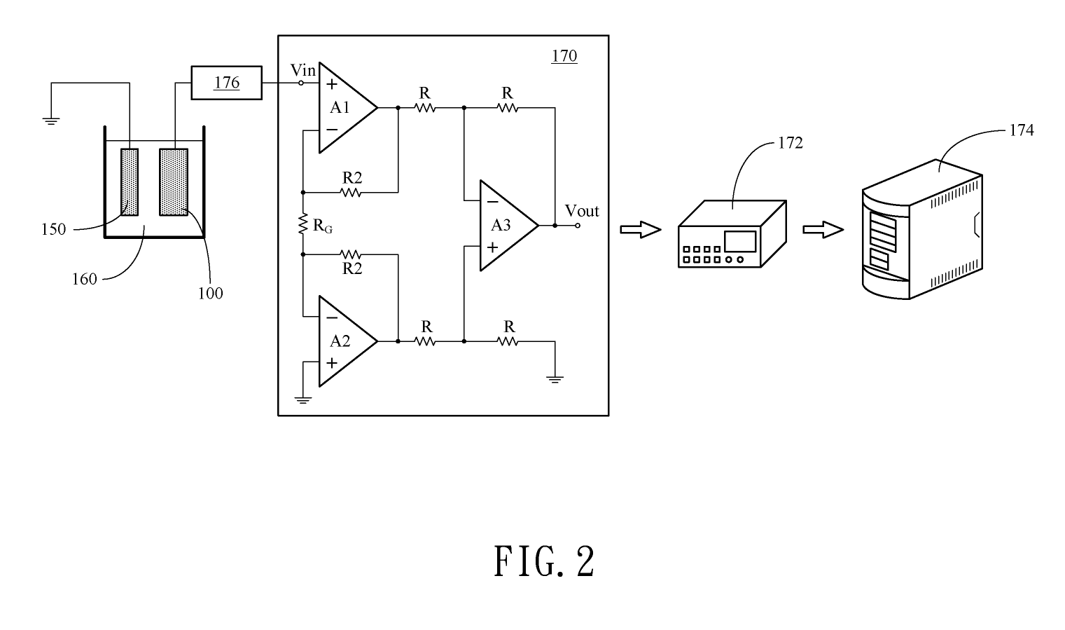

In terms of experiments, the potential sensitivity of the multi-ion potential sensor 100 is about 50 mV/pH-60 mV/pH when the pH range is between pH 2 and pH 12. The average potential sensitivity is about 59 mV/pH, as shown in FIG. 3 and FIG. 4. The calculation of the average potential sensitivity is shown as follows: (the highest potential−the lowest potential)/( the highest pH−the lowest pH).

Please refer to FIG. 2, the multi-ion potential system further comprises a plurality of amplifiers (LT1167) 170, a digital multi-meter (HP 3478A) 172 and a computer 174, wherein each of the amplifiers 170 is electronically coupled with each of the readout areas 112 respectively for amplifying the potential signals from the multi-ion potential sensor 100. The digital multi-meter 172 is electronically coupled with each of the amplifiers 170 respectively for measuring the output signals from each of the amplifiers 170 to output measurement values, wherein each of the measurement values and the output signals from each of the amplifiers 170 are corresponding, and each of the measurement values is analyzed by the computer 174 for acquiring the information of ions in the sample solution 160. The circuit diagram of the amplifier 170 could be shown as FIG. 2.

The digital multi-meter 172 could be a multi-channel circuit for reading out signals from the multi-ion potential sensor 100, which the multi-channel circuit could be integrated by commercialized electronic elements, wherein the signals from the multi-ion potential sensor 100 are transmitted to the computer 174 by a retrieving interface set according to characteristic of the electronic elements. The signals from the multi-ion potential sensor 100 could be corrected and analyzed by the computer 174 because the computer 174 is provided with a planned software.

In addition, each of the amplifiers 170 could be electronically coupled with each of the readout areas 112 by a separable device 176 for adding various advantages to the multi-ion potential sensor 100, such as the multi-ion potential sensor 100 could be portable and disposable, wherein the separable device 176 comprises a plurality of conductive pins, wherein the separable device comprises at least one or any combination of the following: USB (Universal Serial Bus), SD Card (Secure Digital Card), CF Card (Compact Flash Card), SM Card (Smart Media Card), Mini Card, MMC (Multimedia Card) and the socket thereof for transmitting signals and possessing the various advantages. For example, the SD Card could be connected with the amplifier 170, and the socket of the SD Card could be connected with the readout area 112. Besides, a plurality of conductive pins in the separable device 176 could be golden fingers.

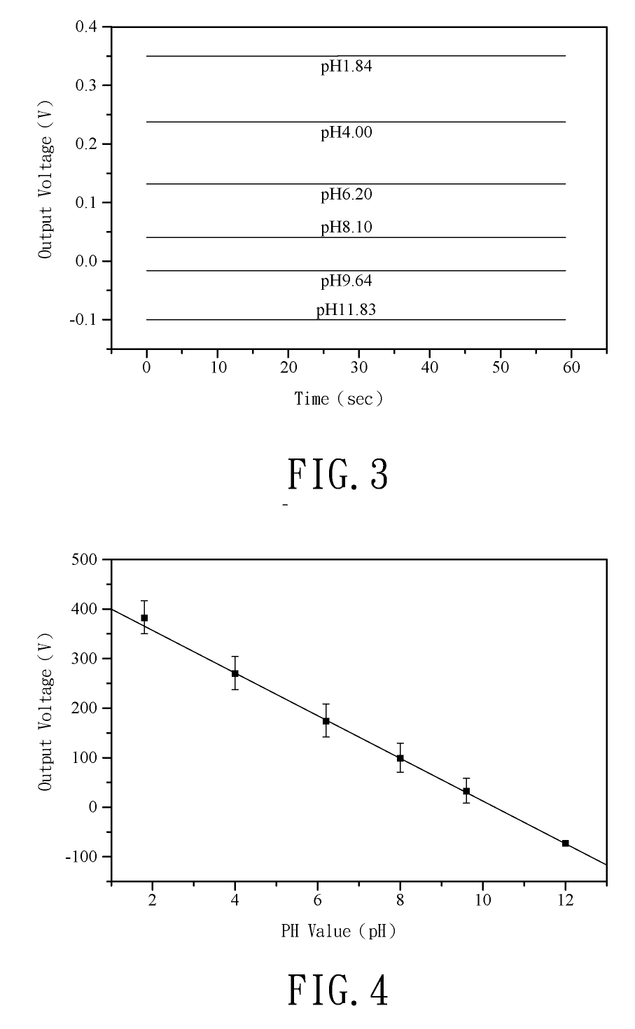

Traditional reference Ag/AgCl electrode must contain electrolyzed solution for working, but the invention provides a solid-state reference electrode 180 without electrolyzed solution for avoiding the above-mentioned difficulty and microminiaturizing the solid-state reference electrode 180. Please refer to FIG. 5, the solid-state reference electrode 180 comprises a silver layer 182, a silver oxide (AgCl) layer 184, an ion containing polymer 186 and an insulation layer 188, wherein the sectional drawing of the solid-state reference electrode 180 is shown as FIG. 6. The silver layer 182 is connected with a wire 190; the silver oxide layer 184 is formed around the silver layer 182; the ion containing polymer 186 is formed around the silver oxide layer 184; and the insulation layer 188 is formed around the place of connection between the silver layer 182 and the wire 190. The ion containing polymer 186 comprises PVC-COOH (Poly Vinyl Chloride Carboxylated), DOS (Bis(2-ethylhexyl)Sebacate), KCl powder and THF (Tetrahydroofuran), wherein PVC-COOH, DOS and KCl powder are mix together with the weight ratios of 33:66:1. The PVC-COOH could be 66 mg; the DOS could be 33 mg; the KCl powder could be 5 mg; and the volume of the THF could be 0.375 ml.

A solid-state reference electrode 180 fabrication method is disclosed, wherein the method comprises the steps of: providing the silver layer 182 which is connected with the wire 190; electrifying the silver layer 182 to form the silver oxide layer 184 around the silver layer 182; forming the ion containing polymer 186 around the silver oxide layer 184; and forming the insulation layer 188 around the place of connection between the silver layer 182 and the wire 190.

The fabrication method of the ion containing polymer 186 comprises the steps of: mixing PVC-COOH, DOS and KCl powder; adding THF to PVC-COOH, DOS and KCl powder; and stirring PVC-COOH, DOS, KCl powder and THF in an ultrasonic bath.

The invention further provides a calibration procedure to calibrate the multi-ion potential sensor 100, wherein the calibration procedure comprises the steps of: immersing the multi-ion potential sensor 100 into a first calibration solution, and measuring a first output potential Y₁ from the multi-ion potential sensor 100, wherein the first calibration solution includes a first ion concentration X₁; immersing the multi-ion potential sensor 100 into a second calibration solution, and measuring a second output potential Y₂ from the multi-ion potential sensor 100, wherein the second calibration solution includes a second ion concentration X₂; and deriving the slope of the equation “Y=A+B X”.

The slope of the equation “Y=A+B X” is derived by the following steps, which comprises: deriving a first equation “Y₁=A+B X₁” by substituting the first output potential Y₁ and the first ion concentration X₁ into the equation “Y=A+B X”; deriving a second equation “Y₂=A+B X₂” by substituting the first output potential Y₂ and the first ion concentration X₂ into the equation “Y=A+B X”; and deriving the solution “A” and “B” by solving simultaneous equations of the first equation “Y₁=A+B X₁” and the second equation “Y₂=A+B X₂”, wherein “A” is the potential from the multi-ion potential sensor, and “B” is the slope of the equation “Y=A+B X” when “X” is zero.

After the calibration procedure is executed, the multi-ion potential sensor 100 is immersed into a sample solution for measuring an output potential from the multi-ion potential sensor 100 and deriving “X” by substituting the output potential into “Y”, wherein “X” is an ion concentration of the sample solution, and “Y” is the output potential of the multi-ion potential sensor 100.

Because the material of one of the selective areas 122 could be different from another, each of the selective areas 122 would have its own sensitivity graph, or there would be a corresponding equation with each of the selective areas 122. According to experiments, the sensitivity graph of pH is shown as FIG. 4 when the ion concentration, the first ion concentration and the second ion concentration comprise hydrogen ion concentration (pH).

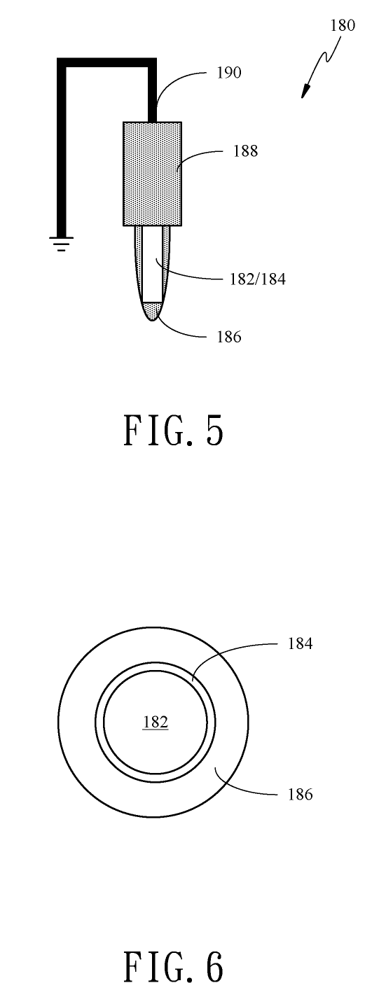

The sensitivity graph of the potassium ion concentration is shown as FIG. 7 when the sample solution, the first calibration solution and the second calibration solution comprise KCl solution; the materials of selective areas comprise potassium ion-selective membrane; and the ion concentration, the first ion concentration and the second ion concentration comprise potassium ion concentration.

In the same way, the sensitivity graph of the sodium ion concentration is shown as FIG. 8 when the sample solution, the first calibration solution and the second calibration solution comprise NaCl solution; the materials of selective areas comprise sodium ion-selective membrane; and the ion concentration, the first ion concentration and the second ion concentration comprise sodium ion concentration.

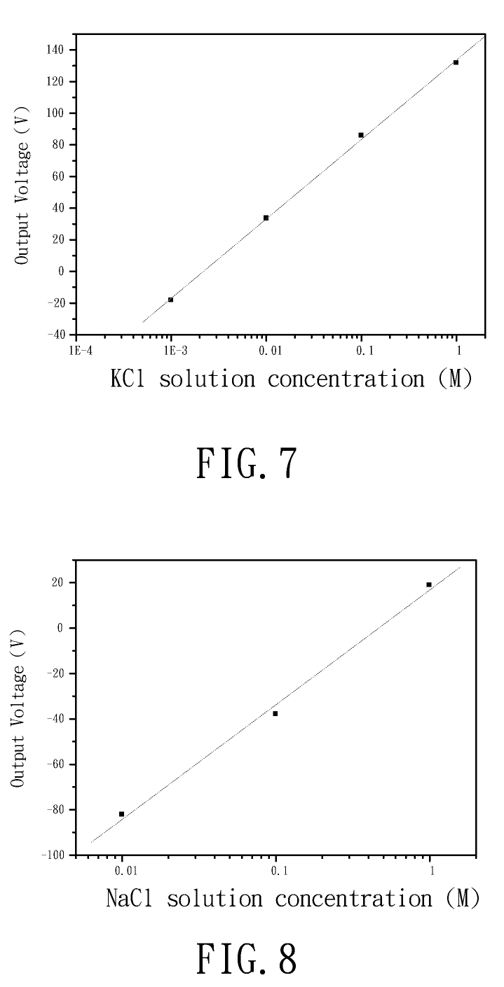

As shown in FIG. 9, a urea enzyme film 123 could be immobilized on one of the selective areas 122 by a photopolymer, wherein the photopolymer comprises poly (vinyl alcohol)-styrylpyridinium (PVA-SbQ) with components as follows: Poly (vinyl alcohol) Bearing Styrylpyridinium Groups, (degree of polymerization 3500, degree of saponification 88, betaine Sbq 1.05 mol %, solid content 10.22 mol %, pH 5.7, SPP-H-13). Following are the components of the urea enzyme film: after diluted with a 125 mg/100 μl, pH=7.0 5 mmole/l phosphate solution, PVA-SbQ mixed with a urea solution (a 10 mg/100 μl, pH 7.0, 5 mmole/l phosphate solution) in the ratio of 1:1.

Upon the operation, the above mixed solution of urea/ PVA-SbQ about 10 μl can be fetched and dropped on the SnO₂, and then the multi-ion potential sensor 100 can be placed and irradiated with an 4W ultraviolet light at 365 nm for 20 min. Since the illumination of the above ultraviolet light, which utilize the feature that a photopolymer will be polymerized during ultraviolet light exposure, can immobilize the urea enzyme on the selective area 122, and then complete the fabrication of the urea sensor.

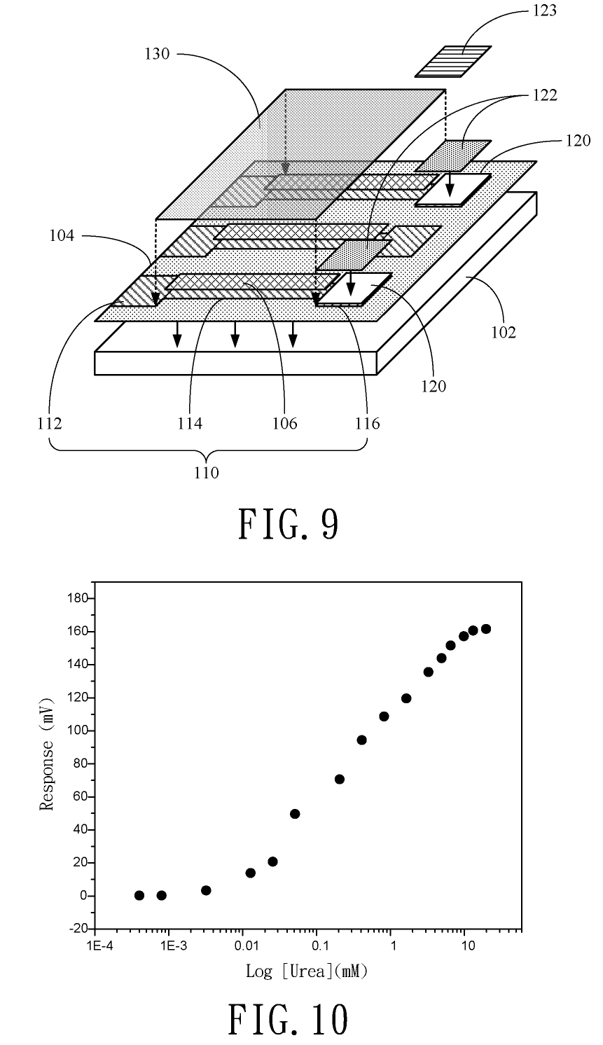

As shown in FIG. 10, the response potential results of a solution for measuring urea with a concentration ranging from 0.8 μmole/1 to 10 mmole/l and the pH value 7.5, are measured by the potentiometric urea sensor, using the measurement circuit shown in FIG. 9.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A multi-ion potential system, comprising:
a solid-state reference electrode with a reference potential;
a multi-ion potential sensor, comprising:
a substrate;
a conductive layer, comprising a plurality of independent conductive areas on said substrate, wherein each of said conductive areas comprises a readout area, a transmissive area and a sensing area;
an isolation layer, formed over each of said transmissive areas;
a tin oxide (SnO₂) layer, comprising a plurality of independent tin oxide areas, wherein each of said tin oxide areas is respectively deposited on each of said sensing areas; and
a selective layer comprising a plurality of independent selective areas, wherein each of selective areas is respectively set on each of said tin oxide areas; and
a plurality of amplifiers, wherein each of said amplifiers is electronically coupled with each of said readout areas respectively.

2. A multi-ion potential system of claim 1, further comprising:
a digital multi-meter, electronically coupled with each of said amplifiers respectively and outputting measurement values after measuring output signals from each of said amplifiers, wherein each of said measurement values is resulted in accordance with each of said output signals; and
a computer, electronically coupled with said digital multi-meter to compute said measurement values from said digital multi-meter.

3. A multi-ion potential system of claim 1, wherein each of said amplifiers is electronically coupled with each of said readout areas by a separable device, wherein said separable device comprising a plurality of conductive pins, which are golden fingers, wherein said separable device comprises at least one or any combination of the following: USB (Universal Serial Bus), SD Card (Secure Digital Card), CF Card (Compact Flash Card), SM Card (Smart Media Card), Mini Card, and MMC (Multimedia Card).

4. A multi-ion potential system of claim 1, further comprising a solution, wherein said solid-state reference electrode and each of said selective areas are immersed into said solution.

5. A multi-ion potential system of claim 1, wherein said conductive layer and said substrate are bound by a first conductive paste, and said isolation layer and each of said transmissive areas are bound by a second conductive paste, wherein said first and said second conductive paste comprise at least one or any combination of the following: carbon paste and silver paste.

6. A multi-ion potential system of claim 1, wherein said substrate comprises at least one or any combination of the following: PP (Polypropylene), PC (Polycarbonate), Fluoroethylene Resin, Phenol Resin, UPE (Unsaturated Polyester Resin), Epoxy Resin, Silicone Resins, PU (Polyurethane), PET (Polyrthylene Terephthalate) and PVC (Polyvinyl chloride polymer).

7. A multi-ion potential system of claim 1, wherein said isolation layer comprises at least one or any combination of the following: Epoxy, Silicone, Silica and Silicon Nitride.

8. A multi-ion potential system of claim 1, wherein material of one of said selective areas is different from another, wherein material of each of said selective areas comprises at least one or any combination of the following: sodium ion-selective membrane and potassium ion-selective membrane.

9. A multi-ion potential system of claim 1, wherein said solid-state reference electrode comprises:
a silver layer, connected with a wire;
a silver oxide (AgCl) layer, formed around said silver layer;
an ion containing polymer, formed around said silver oxide layer; and
an insulation layer, formed around the place of connection between said silver layer and said wire.

10. A multi-ion potential system of claim 9, wherein said ion containing polymer comprises PVC-COOH (Poly Vinyl Chloride Carboxylated), DOS (Bis(2-ethylhexyl)Sebacate), KCl powder and THF (Tetrahydroofuran).

11. A multi-ion potential system of claim 1, wherein said multi-ion potential sensor is calibrated by executing a calibration procedure, comprising the steps of:
immersing said multi-ion potential sensor into a first calibration solution, and measuring a first output potential Y₁ from said multi-ion potential sensor, wherein said first calibration solution includes a first ion concentration X₁;
immersing said multi-ion potential sensor into a second calibration solution, and measuring a second output potential Y₂ from said multi-ion potential sensor, wherein said second calibration solution includes a second ion concentration X₂; and
deriving the slope of the equation “Y=A+B·X” by the following steps, which comprises:
deriving a first equation “Y₁=A+B·X₁” by substituting said first output potential Y₁ and said first ion concentration X₁ into the equation “Y=A+B·X”;
deriving a second equation “Y₂=A+B·X₂” by substituting said first output potential Y₂ and said first ion concentration X₂ into the equation “Y=A+B·X”; and
deriving the solution “A” and “B” by solving simultaneous equations of said first equation “Y₁=A+B·X₁” and said second equation “Y₂=A+B·X₂”, wherein “A” is the potential from said multi-ion potential sensor, and “B” is the slope of the equation “Y=A+B·X” when “X” is zero.

12. A multi-ion potential system of claim 11, wherein said calibration procedure further comprises the steps of:
immersing said multi-ion potential sensor into a sample solution and measuring a output potential from said multi-ion potential sensor; and
deriving “X” of the equation “Y=A+B·X” by substituting said output potential into “Y” of the equation “Y=A+B·X”, wherein “X” is an ion concentration of said sample solution, and “Y” is said output potential from said multi-ion potential sensor.

13. A multi-ion potential system of claim 12, wherein said ion concentration, said first ion concentration and said second ion concentration comprise at least one or any combination of the following: hydrogen ion concentration, sodium ion concentration and potassium ion concentration.

14. A multi-ion potential system of claim 1, wherein said multi-ion potential sensor comprises a urea enzyme film, wherein said urea enzyme film is set on one of said selective areas.

15. A multi-ion potential sensor fabrication method, comprising the steps of:
providing a substrate;
forming a conductive layer on said substrate by using screen-printed method, wherein said conductive layer comprises a plurality of independent conductive areas, and each of said conductive areas comprises a readout area, a transmissive area and a sensing area, wherein said readout area is connected with one side of said transmissive area, and said sensing area is connected with the other side of said transmissive area;
deposting a tin oxide layer on said conductive layer by vapor deposition method, wherein said tin oxide layer comprises a plurality of independent tin oxide areas, and each of said tin oxide areas is respectively deposited on each of said sensing areas;
forming an isolation layer over each of said transmissive areas;
forming a selective layer on said tin oxide layer, wherein said selective layer comprises a plurality of independent selective areas, and each of said selective areas is set on each of said tin oxide areas.

16. A multi-ion potential sensor fabrication method of claim 15, further comprising the steps of:
binding said conductive layer and said substrate by a first conductive paste; and
binding said isolation layer and each of said transmissive areas by a second conductive paste, wherein said first and said second conductive paste comprise at least one or any combination of the following: carbon paste and silver paste.

17. A multi-ion potential sensor fabrication method of claim 15, wherein said substrate comprises at least one or any combination of the following: PP, PC, Fluoroethylene Resin, Phenol Resin, UPE, Epoxy Resin, Silicone Resins, PU, PET) and PVC.

18. A multi-ion potential sensor fabrication method of claim 15, wherein said isolation layer comprises at least one or any combination of the following: Epoxy, Silicone, Silica and Silicon Nitride.

19. A multi-ion potential sensor fabrication method of claim 15, wherein the material of one of said selective areas is different from another, wherein material of each of said selective areas comprises at least one or any combination of the following: sodium ion-selective membrane and potassium ion-selective membrane.

20. A multi-ion potential sensor fabrication method of claim 15, wherein said vapor deposition method comprises at least one or any combination of the following: PVD (Physical Vapor Deposition) and CVD (Chemical Vapor Deposition).

21. A multi-ion potential sensor fabrication method of claim 20, wherein said physical vapor deposition comprises at least one or any combination of the following: evaporation deposition, ion plating and sputtering deposition.

22. A multi-ion potential sensor fabrication method of claim 21, wherein said sputtering deposition comprises RF Sputter.

23. A multi-ion potential sensor fabrication method of claim 20, wherein said chemical vapor deposition comprises at least one or any combination of the following: LPCVD (Low Pressure Chemical Vapor Deposition), MPCVD (Metal-organic Chemical Vapor Deposition), PECVD (Plasma-Enhanced Chemical Vapor Deposition) and Photo CVD.

24. A multi-ion potential sensor fabrication method of claim 15, further comprising the steps of:
immobilizing a urea enzyme film on one of said selective areas by a photopolymer.

25. A multi-ion potential sensor fabrication method of claim 24, wherein said photopolymer comprises poly (vinyl alcohol)-styrylpyridinium (PVA-SbQ) with components as follows: Poly (vinyl alcohol) Bearing Styrylpyridinium Groups, (degree of polymerization 3500, degree of saponification 88, betaine Sbq 1.05 mol %, solid content 10.22 mol %, pH 5.7, SPP-H-13).

26. A multi-ion potential sensor fabrication method of claim 24, wherein the fabrication of said urea enzyme film comprises the steps of:
diluting with a 125 mg/100 μl, pH=7.0 5 mmole/1 phosphate solution, PVA-SbQ; and
mixing said PVA-SbQ with a urea solution (a 10 mg/100 μl, pH 7.0, 5 mmole/l phosphate solution) in the ratio of 1:1.

27. A solid-state reference electrode fabrication method, comprising the steps of:
providing a silver layer which is connected with a wire;
electrifying said silver layer to form a silver oxide (AgCl) layer around said silver layer;
forming an ion containing polymer around said silver oxide layer; and
forming an insulation layer around the place of connection between said silver layer and said wire.

28. A solid-state reference electrode fabrication method of claim 27, wherein the fabrication method of said ion containing polymer comprises the steps of:
mixing PVC-COOH, DOS and KCl powder;
adding THF solution to PVC-COOH, DOS and KCl powder; and
stirring PVC-COOH, DOS, KCl powder and THF in an ultrasonic bath.

29. A solid-state reference electrode fabrication method of claim 28, wherein PVC-COOH, DOS and KCl powder are mix together with the weight ratios of 33:66:1.
